(19) United States
(12) Patent Application Publication
(10) Pub. No.: US 2004/0008914 A1
(43) Pub. Date: Jan. 15, 2004

(54) Plain bearing

(76) Inventors: Nobutaka Hiramatsu, Inuyama-Shi (JP); Takuya Tanaka, Inuyama-Shi (JP); Hideyuki Nakajima, Inuyama-Shi (JP); Masahito Fujita, Inuyama-Shi (JP); Takayuki Shibayama, Inuyama-Shi (JP)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/419,476

(22) Filed: Apr. 21, 2003

(30) Foreign Application Priority Data
Jun. 14, 2002 (JP) 2002-174278

(51) Int. Cl. F16C 33/02

(52) U.S. Cl. 384/276; 384/907

(57) ABSTRACT

The present invention provides a plain bearing comprising a substrate and a sliding layer provided on the surface of the substrate which is improved in bearing performances, particularly, wear resistance. According to the present invention, the sliding layer 2 provided on the surface of the substrate 1 comprising a steal material or stainless steal contains polybenzimidazole (PBI) and 1-70 vol% of a solid lubricant. PBI is superior in heat resistance to thermosetting resins (PAI, PI, EP resins) and, besides, high in material strength, and thus wear resistance and anti-seizure property can be improved.

### BACKGROUND OF THE INVENTION

The present invention relates to a plain bearing which comprises a substrate comprising a steel material or stainless steel and a sliding layer provided on the surface of the substrate.

For example, plain bearings for engines of automobiles, have been improved in wear resistance, anti-seizure property and initial conformability by providing a sliding layer comprising a thermosetting resin such as a polyamide-imide (hereinafter referred to as “PAI”) resin, a polyimide (hereinafter referred to as “PI”) resin or an epoxy (hereinafter referred to as “EP”) resin containing a solid lubricant or the like on the surface of a substrate comprising a back metal made of a steel sheet and a bearing alloy layer provided on the back metal (see, for example, JP-A-4-83914 and JP-A-9-79262).

Furthermore, JP-A-8-59991 discloses resin-based sliding materials comprising PAI and PI as base resins which contain solid lubricants and hard particles.

However, the above-mentioned conventional plain bearings are all insufficient in wear resistance.

### SUMMARY OF THE INVENTION

The object of the present invention is to provide a plain bearing comprising a substrate and a sliding layer provided on the surface of the substrate which is further improved in bearing performances, particularly, wear resistance.

In the present invention for attaining the above object, the plain bearing comprises a substrate comprising a steel material or stainless steel and a sliding layer provided on the surface of the substrate, where said sliding layer contains polybenzimidazole (hereinafter referred to as “PBI”) and 1-70 vol% of a solid lubricant.

TABLE 1

| | PBI resin | |
|---|---|---|
| | (Polybenzimidazole) | PI resin |
| Tensile strength | 127 | 90˜120 |
| Elongation (%) | 30 | 8˜23 |
| Heat distortion temperature (° C.) | 427 | 272 |

The above Table 1 shows physical properties of the PBI resin which is a base resin of the sliding layer. The PBI resin which is a thermoplastic resin is superior in heat resistance to the conventionally used thermosetting resins (PAI, PI and EP resins) and furthermore is high in material strength. Therefore, wear resistance and anti-seizure property of the plain bearing can be improved by using the PBI resin. Furthermore, since decrease of material strength in a high-temperature atmosphere and decrease of material strength caused by heat generated during the sliding operation are small, satisfactory wear resistance can be maintained even during the sliding at high temperatures. Moreover, the PBI resin has extensibility and, hence, initial conformability can be improved by using the PBI resin.

Furthermore, the sliding layer contains a solid lubricant, which can also reduce the coefficient of friction and improve anti-seizure property. In this case, if the content of the solid lubricant is less than 1 vol %, the effect to improve lubricity can hardly be obtained, and if it is more than 70 vol %, the wear resistance is deteriorated. Therefore, the content of the solid lubricant is preferably 1-70 vol %.

As the solid lubricant, it is preferred to use at least one of polytetrafluoroethylene (hereinafter referred to as “PTFE”), graphite and molybdenum disulfide.

It is preferred that the sliding layer contains 0.1-10 vol % of hard particles.

The hard particles contribute to the improvement of wear resistance. Therefore, the wear resistance of the plain bearing can be further improved by adding the hard particles to the sliding layer. As the hard particles, there may be used, for example, titanium oxide, alumina, silicon nitride, tin oxide and boron nitride. In this case, if the content of the hard particles is less than 0.1 vol %, the effect to improve wear resistance by the hard particles cannot be obtained, and if it is more than 10 vol %, coefficient of friction increases, and, as a result, mating members are apt to be damaged and additionally anti-seizure property is deteriorated. Therefore, the content of the hard particles is preferably 0.1- 10 vol %.

It is preferred that the sliding layer contains 0.1-15 vol % of an oil.

Since oil contributes to the improvement of lubricity, coefficient of friction can be reduced and anti-seizure property can be improved by adding an oil to the sliding layer. In this case, if the content of the oil is less than 0.1 vol %, the effect to improve lubricity by the oil cannot be obtained, and if it is more than 15 vol %, wear resistance is deteriorated. Therefore, the content of the oil is preferably 0.1-15 vol %. The oil includes, for example, mineral oil, synthetic oil, etc.

It is preferred to provide a bonding layer comprising a thermosetting resin between the substrate and the sliding layer.

By providing a bonding layer comprising a thermosetting resin of high bonding force between the substrate and the sliding layer, bonding force of the sliding layer to the substrate can be further improved and peeling of the sliding layer can be inhibited. The thermosetting resins are preferably PAI, PI, EP and phenolic resin.

During the use of plain bearings, there may occur a phenomenon that cavities (air bubbles) are produced in lubricating oil to cause erosion of the surface of bearings. This is a phenomenon that the cavities produced in the lubricating oil are broken under a high pressure, and energy generated at the breakage of the cavities erosionally wears the surface of the bearing. For inhibiting occurrence of this phenomenon, cavitation properties have been improved by enhancing the material strength of the sliding layer. Furthermore, if the bonding between the substrate and the sliding layer is lower than the material strength of the sliding layer, separation occurs at the interface when a slight vibration of high pressure is applied thereto. In order to improve the bonding, there is employed a technology of roughening the surface of the substrate by a surface treatment, but further improvement of the bonding is desired. Under the circumstances, the bonding between the substrate and the sliding layer can be further improved and erosion of the surface of bearings can be further efficiently inhibited by providing a bonding layer between the substrate and the sliding layer.

### BRIEF DESCRIPTION OF THE DRAWINGS

FIG. 1 is a sectional view of a plain bearing of the first embodiment according to the present invention.

FIG. 2 is a sectional view of a plain bearing of the second embodiment according to the present invention.

In these drawings, 1 indicates a substrate, 2 indicates a sliding layer and 3 indicates a bonding layer.

### DETAILED DESCRIPTION OF THE INVENTION

The embodiments of the present invention will be explained below.

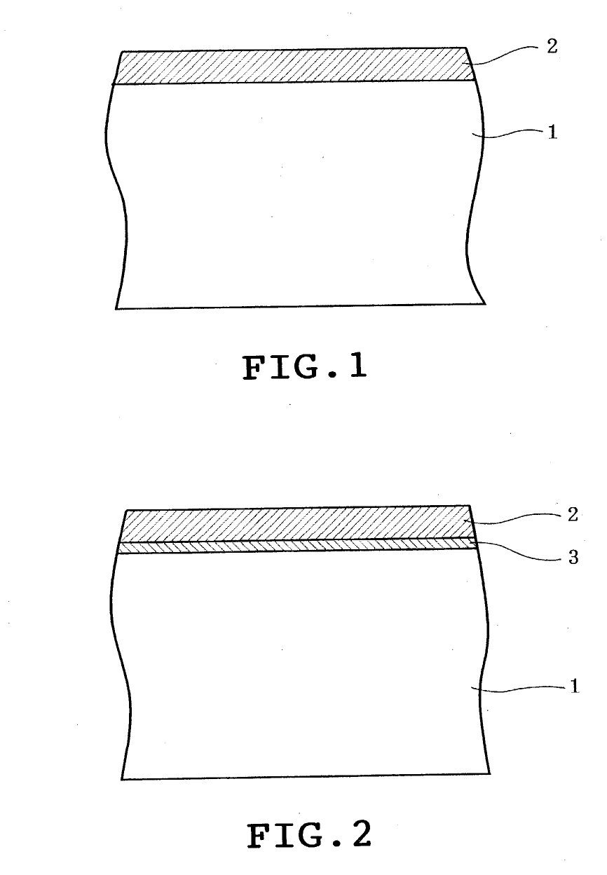

FIG. 1 is a sectional view of a plain bearing which schematically illustrates the first embodiment of the present invention. The plain bearing has such a construction that a sliding layer 2 is provided on the surface of a substrate 1 comprising stainless steel or steel material.

The above plain bearing is produced in the following manner. First, the substrate 1 is worked into the shape of a plain bearing, and then subjected to a degreasing treatment, followed by roughening the surface by a surface treatment. The method of surface treatment for roughening includes shot blasting, etching or the like. Furthermore, the substrate is subjected to pickling to remove impurities deposited on the surface and simultaneously activate the surface. The substrate 1 is washed with warm water and dried, and then a sliding layer composition (namely, a mixture of PBI which is a base resin, a solid lubricant such as molybdenum disulfide and, if necessary, hard particles and oil) diluted with a suitable organic solvent is sprayed on the surface of the substrate 1 by air spraying to coat the composition on the surface, and the coat is heated and cured at 300-400° C., for example, 350° C. for 60 minutes. By this heating, the solvent is evaporated and besides the sliding layer composition containing PBI and solid lubricant is cured, whereby a sliding layer 2 is provided on the surface of the substrate 1. In this case, the thickness of the sliding layer 2 is usually 1-100 μm, preferably 3-50 μm.

The plain bearing can also be produced by carrying out the working into the shape of plain bearing after providing the sliding layer 2 on the substrate 1.

TABLE 2

| | | | Composition of sliding layer (vol %) | | | | | | | | | | | Test results | |
|---|---|---|---|---|---|---|---|---|---|---|---|---|---|---|---|
| | | | Base resin | | | Solid libricant | | | Hard particles | | | | | Coefficient | Amount of |
| | No. | Substrate | PBI | EP | PAI | MoS₂ | Gr | PTFE | TiO₂ | Al₂O₃ | Si₃N₄ | SnO₂ | Oil | of friction | wear(μm) |
| Ex- | 1 | Stainless | Remainder | | | 1 | | | | | | | | 0.10 | 3 |
| ample | | steel | | | | | | | | | | | | | |
| | 2 | Stainless | Remainder | | | 20 | | | | | | | | 0.07 | 5 |
| | | steel | | | | | | | | | | | | | |
| | 3 | Stainless | Remainder | | | 40 | | | | | | | | 0.05 | 8 |
| | | steel | | | | | | | | | | | | | |
| | 4 | Stainless | Remainder | | | 60 | | | | | | | | 0.03 | 8 |
| | | steel | | | | | | | | | | | | | |
| | 5 | Stainless | Remainder | | | 70 | | | | | | | | 0.03 | 9 |
| | | steel | | | | | | | | | | | | | |
| | 6 | Stainless | Remainder | | | | 40 | | | | | | | 0.04 | 7 |
| | | steel | | | | | | | | | | | | | |
| | 7 | Stainless | Remainder | | | | | 20 | | | | | | 0.05 | 6 |
| | | steel | | | | | | | | | | | | | |
| | 8 | Stainless | Remainder | | | | | 40 | | | | | | 0.03 | 9 |
| | | steel | | | | | | | | | | | | | |
| | 9 | Stainless | Remainder | | | 40 | | | | | | 1 | | 0.07 | 4 |
| | | steel | | | | | | | | | | | | | |
| | 10 | Stainless | Remainder | | | 40 | | | | | | 5 | | 0.07 | 2 |
| | | steel | | | | | | | | | | | | | |
| | 11 | Stainless | Remainder | | | 40 | | | | | | 10 | | 0.09 | 4 |
| | | steel | | | | | | | | | | | | | |
| | 12 | Stainless | Remainder | | | 40 | | | | | 3 | | | 0.04 | 1 |
| | | steel | | | | | | | | | | | | | |
| | 13 | Stainless | Remainder | | | 40 | | | | 3 | | | | 0.05 | 2 |
| | | steel | | | | | | | | | | | | | |
| | 14 | Stainless | Remainder | | | 40 | | | 3 | | | | | 0.04 | 1 |
| | | steel | | | | | | | | | | | | | |
| | 15 | Stainless | Remainder | | | 40 | | | | | | 3 | 1 | 0.02 | 1 |
| | | steel | | | | | | | | | | | | | |
| | 16 | Stainless | Remainder | | | 40 | | | | | | 3 | 5 | 0.01 | 3 |
| | | steel | | | | | | | | | | | | | |
| | 17 | Stainless | Remainder | | | 40 | | | | | | 3 | 10 | 0.01 | 4 |
| | | steel | | | | | | | | | | | | | |
| | 18 | Stainless | Remainder | | | 40 | | | | | | 3 | 15 | 0.01 | 8 |
| | | steel | | | | | | | | | | | | | |
| | 19 | Steel material | Remainder | | | 40 | | | | | | | | 0.06 | 7 |
| | 20 | ″ | Remainder | | | | 40 | | | | | | | 0.05 | 7 |
| | 21 | ″ | Remainder | | | | | 40 | | | | | | 0.03 | 9 |
| | 22 | ″ | Remainder | | | 40 | | | | 3 | | | | 0.04 | 3 |
| | 23 | ″ | Remainder | | | 40 | | | | | 3 | | 5 | 0.01 | 2 |

TABLE 3

| | | | Composition of sliding layer (vol %) | | | | | | | | | | | Test results | |
|---|---|---|---|---|---|---|---|---|---|---|---|---|---|---|---|
| | | | Base resin | | | Solid lubricant | | | Hard particles | | | | | Coefficient | Amount of |
| | No. | Substrate | PBI | EP | PAI | MoS₂ | Gr | PTFE | TiO₂ | Al2O₃ | Si₃N₄ | SnO₂ | Oil | of friction | wear (μm) |
| Comparative | 1 | Stainless | | | Remainder | 40 | | | | | | | | 0.05 | 17 |
| Example | | steel | | | | | | | | | | | | | |
| | 2 | Stainless | | | Remainder | | 40 | | | | | | | 0.06 | 17 |
| | | steel | | | | | | | | | | | | | |
| | 3 | Stainless | | | Remainder | | | 40 | | | | | | 0.04 | 15 |
| | | steel | | | | | | | | | | | | | |
| | 4 | Stainless | | | Remainder | 40 | | | | | 3 | | | 0.05 | 11 |
| | | steel | | | | | | | | | | | | | |
| | 5 | Stainless | | | Remainder | 40 | | | 3 | | | | | 0.06 | 11 |
| | | steel | | | | | | | | | | | | | |
| | 6 | Stainless | | Remainder | | 40 | | | | | | | | 0.07 | 19 |
| | | steel | | | | | | | | | | | | | |
| | 7 | Stainless | | Remainder | | | 40 | | | | | | | 0.07 | 18 |
| | | steel | | | | | | | | | | | | | |

Table 2 shows compositions of the substrate and the sliding layer of the samples obtained as mentioned above in Examples 1-23 of the present invention. In the samples of Examples 1-18 in Table 2, the substrate was stainless steel, and in the samples of Examples 19-23, the substrate was a steel material. The base resin in the composition of the sliding layer was PBI in all of the samples. The contents of the components in the sliding layer were 1-70 vol % of the solid lubricant, 1-10 vol% of the hard particles and 1-15 vol % of the oil. Molybdenum disulfide (MOS₂), graphite (Gr) or PTFE was used as the solid lubricant, titanium oxide (TiO₂), alumina (Al₂O₃), silicon nitride (Si₃N₄) or tin oxide (SnO₂) was used as the hard particles, and an Si-based synthetic oil was used as the oil.

Table 3 shows compositions of the substrate and the sliding layer of the samples of Comparative Examples 1-7 in comparison with Examples 1-23 of the present invention. In this Table 3, all the substrates of Comparative Examples 1-7 were stainless steel. The base resin of the sliding layer was PAI or EP. In these Comparative Examples 1-7, the temperature for heating and curing the sliding layer was 250° C. and the heating time was 60 minutes.

A frictional wear test was conducted on the samples of Examples 1-23 of the present invention and those of Comparative Examples 1-7, and the results are shown in Tables 2 and 3. The frictional wear test was conducted under the test conditions shown in Table 4 using a thrust type frictional wear tester, and coefficient of friction and an amount of wear were measured.

TABLE 4
Frictional wear test conditions

| Items | Test Condition |
|---|---|
| Surface pressure | 10 MPa |
| Peripheral speed | 0.5 m/s |
| Testing time | 4 Hrs |
| Method of lubrication | Oil bath |

The examples and the comparative examples are compared. First, Examples 3 and 19 are compared with Comparative Examples 1 and 6. In these examples and comparative examples, the solid lubricant in the sliding layer was the same (MoS₂) and the content thereof was also the same (40 vol %). It can be seen from the test results that the coefficient of friction was nearly the same, but the amount of wear was 17 μm and 19 μm in Comparative Examples 1 and 6 while it was 8 μm and 7 μm in Examples 3 and 19, and thus the samples of Examples 3 and 19 were superior in wear resistance.

Examples 6 and 20 are compared with Comparative Examples 2 and 7. In these examples and comparative examples, the solid lubricant in the sliding layer was also the same (Gr) and the content thereof was also the same (40 vol %). It can be seen from the test results that the coefficient of friction was nearly the same, but the amount of wear was less in Examples 6 and 20, and thus the samples of Examples 6 and 20 were superior in wear resistance to those of Comparative Examples 2 and 7.

Example 8 is compared with Comparative Example 3. In these example and comparative example, the solid lubricant in the sliding layer was also the same (PTFE) and the content thereof was also the same (40 vol %). It can be seen from the test results that the coefficient of friction was nearly the same, but the amount of wear was less in Example 8, and thus the sample of Example 8 was also superior in wear resistance to that of Comparative Example 3.

Example 12 is compared with Comparative Example 4. In these example and comparative example, the solid lubricant and the hard particles in the sliding layer were the same (MoS₂ and Si₃N₄) and the contents thereof were the same (40 vol % and 3 vol %). It can be seen from the test results that the coefficient of friction was nearly the same, but the amount of wear was less in Example 12, and thus the sample of Example 12 was also superior in wear resistance to that of Comparative Example 4.

Example 14 is compared with Comparative Example 5. In these example and comparative example, the solid lubricant and the hard particles in the sliding layer were also the same (MoS₂ and TiO₂) and the contents thereof were also the same (40 vol % and 3 vol %). It can be seen from the test results that the coefficient of friction was nearly the same, but the amount of wear was less in Example 14, and thus the sample of Example 14 was also superior in wear resistance to that of Comparative Example 5.

Examples 1-5 are examined. These are the same in the solid lubricant, but different in the content thereof. In Example 1 where the content of the solid lubricant was 1 vol %, the coefficient of friction was higher than in other examples, and it is presumed that if the content is less than 1 vol %, the effect to improve the lubricity by the solid lubricant can hardly be obtained. Furthermore, in Example 5 where the content of the solid lubricant was 70 vol %, the amount of wear was larger than in other examples, and it is presumed that if the content exceeds 70 vol%, the amount of wear further increases. Therefore, the content of the solid lubricant is preferably 1-70 vol %.

Example 3 and Examples 9-14 and 22 are examined. The hard particles were not added to the sliding layer in Example 3 while the hard particles were added to the sliding layer in Examples 9-14 and 22. The amount of wear in Example 3 where the hard particles were not added was 8 μm while the amount of wear in Example 9-14 and 22 where the hard particles were added was 1-4 μm. Thus, it can be seen that the samples in which the hard particles were added were superior in wear resistance to those in which the hard particles were not added. Moreover, among samples of Examples 9-14 and 22, the sample of Example 11 where the content of the hard particles was 10 vol % was higher in coefficient of friction than the samples of other examples. Moreover, when the content of the hard particles was smaller, the effect to improve wear resistance by the hard particles could not be obtained. Therefore, the content of the hard particles in the sliding layer is preferably 0.1-10 vol %.

Examples 12-14 and 22 and Examples 15-18 and 23 are examined. In Examples 12-14 and 22, the hard particles were added to the sliding layer, but oil was not added. On the other hand, in Examples 15-18 and 23, the hard particles and the oil were added to the sliding layer. In Examples 15-18 and 23 where the hard particles and the oil were added to the sliding layer, the coefficient of friction was low, namely, not higher than 0.02, and it can be seen that the frictional wear characteristic was particularly excellent. Furthermore, among Examples 15-18 and 23, in Example 18 where the content of oil was 15 vol %, the amount of wear was greater than in other examples. Further, when the content of oil was low, the effect to improve the lubricity by the oil could not be obtained. Therefore, the content of oil in the sliding layer is preferably 0.1-1 5 vol %.

FIG. 2 is a sectional view of a plain bearing which schematically illustrates the second embodiment of the present invention. This plain bearing has such a construction that a bonding layer 3 comprising a thermosetting resin is provided between the substrate 1 comprising stainless steel or steel material and the sliding layer 2.

The above plain bearing is produced in the following manner. First, as in the first embodiment mentioned above, the substrate 1 is worked into the shape of a plain bearing, and then subjected to a degreasing treatment, followed by roughening the surface by etching. Furthermore, the substrate is subjected to pickling to remove impurities deposited on the surface and simultaneously activate the surface. The substrate 1 is washed with warm water and dried, and then a bonding layer composition (namely, a mixture of a thermosetting resin such as PAI, PI or the like which is a base resin and, if necessary, a solid lubricant such as molybdenum disulfide) diluted with a suitable organic solvent is sprayed on the surface of the substrate 1 by air spraying to coat the composition on the surface, and the coat is heated and cured, for example, at 250° C. for 10 minutes to provide a bonding layer 3. In this case, the thickness of the bonding layer 3 is 5 μm or less. The base resin of the bonding layer 3 may be EP or a phenolic resin as well as PAI and PI.

Thereafter, in the same manner as in the first embodiment, a sliding layer composition (namely, a mixture of PBI which is a base resin, a solid lubricant such as molybdenum disulfide and, if necessary, hard particles and oil) diluted with a suitable organic solvent is sprayed on the surface of the bonding layer 3 by air spraying to coat the surface with the composition, and the coat is heated and cured, for example, at 350° C. for 60 minutes, whereby a sliding layer 2 is provided on the surface of the bonding layer 3. In this case, the thickness of the sliding layer 2 is also usually 1-100 μm, preferably 3-50 μm.

In case the plain bearing has the above construction, bonding of the sliding layer 2 to the substrate 1 can be further improved and peeling of the sliding layer can be inhibited by providing the bonding layer 3 comprising a thermosetting resin of high bonding force between the substrate 1 and the sliding layer 2.

Furthermore, by adding a solid lubricant to the bonding layer 3, the effect provided by the solid lubricant can be expected as in the case of the addition of the solid lubricant to the sliding layer 2, and, hence, abrupt deterioration of sliding characteristics can be prevented even if the sliding layer is worn.

The present invention is not limited to only the above first and second embodiments and can be modified or expanded as mentioned below.

The method for the formation of the sliding layer 2 and the bonding layer 3 is not limited to only the air spraying method, and pad printing method, screen printing method, roll coating method, etc. may be used.

The plain bearings of the present invention can be used for compressors and other uses in addition to engines of automobiles.

In the above embodiments, the plain bearings of the present invention are used under hydrodynamic lubrication as shown in Table 4, but they can also be used under boundary lubrication or under no lubrication.

What is claimed is:

1. A plain bearing which comprises a substrate comprising a steel material or stainless steel and a sliding layer provided on the surface of the substrate, said sliding layer containing polybenzimidazole and 1-70 vol % of a solid lubricant.

2. A plain bearing according to claim 1, wherein the solid lubricant comprises at least one member of polytetrafluoroethylene, graphite and molybdenum disulfide.

3. A plain bearing according to claim 1, wherein the sliding layer contains 0.1-10 vol % of hard particles.

4. A plain bearing according to claim 2, wherein the sliding layer contains 0.1-10 vol % of hard particles.

5. A plain bearing according to claim 1, wherein the sliding layer contains 0.1-15 vol % of an oil.

6. A plain bearing according to claim 2, wherein the sliding layer contains 0.1-15 vol % of an oil.

7. A plain bearing according to claim 3, wherein the sliding layer contains 0.1-15 vol % of an oil.

8. A plain bearing according to claim 4, wherein the sliding layer contains 0.1-15 vol % of an oil.

9. A plain bearing according to claim 1, wherein a bonding layer comprising a thermosetting resin is provided between the substrate and the sliding layer.

10. A plain bearing according to claim 2, wherein a bonding layer comprising a thermosetting resin is provided between the substrate and the sliding layer.

11. A plain bearing according to claim 3, wherein a bonding layer comprising a thermosetting resin is provided between the substrate and the sliding layer.

12. A plain bearing according to claim 4, wherein a bonding layer comprising a thermosetting resin is provided between the substrate and the sliding layer.

13. A plain bearing according to claim 5, wherein a bonding layer comprising a thermosetting resin is provided between the substrate and the sliding layer.

14. A plain bearing according to claim 6, wherein a bonding layer comprising a thermosetting resin is provided between the substrate and the sliding layer.

15. A plain bearing according to claim 7, wherein a bonding layer comprising a thermosetting resin is provided between the substrate and the sliding layer.

16. A plain bearing according to claim 8, wherein a bonding layer comprising a thermosetting resin is provided between the substrate and the sliding layer.
